(19) United States
(12) Patent Application Publication
(10) Pub. No.: US 2006/0293779 A1
(43) Pub. Date: Dec. 28, 2006

(54) Method and a system to communicate and manage work-order information on the manufacturing floor

(76) Inventor: Naomi Nishri, Doar-Na Misgav (IL)

Correspondence Address: Martin Moynihan;PRTSI, Inc., P.O. Box 16446, Arlington, VA, 22215, US

(21) Appl. No.: 11/241,940

(22) Filed: Oct. 4, 2005

Related U.S. Application Data
(60) Provisional application No. 60/693,081, filed on Jun. 23, 2005.

(51) Int. Cl. G06F 19/00

(52) U.S. Cl. 700/115; 700/99

(57) ABSTRACT

A system and a method for communicating a plurality of work-orders to a plurality of users using a plurality of communication units over a factory floor, where each communication units is associated with a different work-order and each work-order is associated with a different communication unit. Each communication units has a user interface to provide work-order information to users and receive work-order information from users.

### RELATIONSHIP TO EXISTING APPLICATIONS

The present application claims priority from U.S. Provisional Patent Application No. 60/693,081, filed on Jun. 23, 2005, the contents of which are incorporated herein by reference.

### FIELD AND BACKGROUND OF THE INVENTION

The present invention relates to the management of work-orders and, more particularly, but not exclusively to communicating work-order information on the manufacturing floor.

A work-order is a document that provides a general description of the work to be carried out to complete a job. Work-orders are typically used to manage manufacturing, maintenance and contractors thereof. For a manufacturing job the work-order may include information such as due delivery time, quantity of items to be manufactured, type and quantities of raw materials and components to be consumed, manufacturing units involved in the manufacturing process, routing and timing information between the manufacturing units, procurement orders, etc. For a maintenance job a work-order may contain information such as maintenance parts, materials, tools and equipment required to complete the job, the labor hours, costs and materials consumed in completing the task, as well as key information on failure causes, what work was performed, etc. The work-order authorizes, assigns, and tracks the completion of the work within an organization.

There are information-processing systems, such as Enterprise Resource Management (ERP) systems and Manufacturing Resource Management (MRP) systems, that manage work-orders as a part of their general task. When work-orders are managed by an information processing system, the work-order may consist of several records or parts of records. When printed, a typical work-order may consist of several paper documents.

A work-order, which is an information entity, is therefore associated with a specific physical entity. This physical entity, especially when it is a manufactured entity, is mobile and evolving. The manufactured entity can be a single unit or a batch of units. A manufactured entity typically undergoes several manufacturing stages, typically each stage is executed in a different manufacturing station in a manufacturing. Hence, the manufactured entity is mobile through the manufacturing floor. In some cases the manufacturing floor may be distributed over several manufacturing sites. In some cases the manufacturing sites may be operated by different business entities. Typically there are several manufacturing work-orders that are processed simultaneously in every manufacturing site. Thus work-orders require continuous updates while being executed. Since the processing of the work-order takes time there may be changes to the work-order, that require the attention of the people involved in the execution of the work-order. A work-order should therefore follow the physical entity with which it is associated and provide continuous output and input of information.

The current information processing systems available in the market, which process work-orders, enable a user to approach one of the system's terminals and interrogate the system about the current status of a specific work-order. This interrogation requires that the user is knowledgeable about the structure of the database and the available means to retrieve the information required. Another major problem is that such terminals do not follow the physical entities that are associated with the work-orders. Printed work-orders can be attached to the physical entities but printed work-orders are never updated.

The prior art does not support automatic or real time management of resources priority. Presently, to reschedule the work order priority of the shop floor resources, an employee has to physically search for the manufacturing station where the work-order is currently processed and manually, and usually verbally, communicate the new schedule information to the manufacturing employee.

The situation at the manufacturing floor is a complex matrix of work-orders, manufacturing resources, products, projects, raw materials, etc. Typically each manufacturing resource executes a group of work-orders, and each work-order may be part of different products and different projects. An individual work order may take a highly individualized path around the manufacturing stations on the factory floor. This complex matrix is in a continuous change. The factory floor environment may thus be considered a chaotic, as opposed to a controlled, environment.

The prior art does not teach an automatic and real time mechanism to communicate work-order priority changes to the manufacturing floor It is especially difficult to communicate work-order updates directly from the central knowledge base station, namely the ERP system, to the manufacturing floor. It further fails to teach any efficient system of feedback of information from the factory floor to the management system.

A disadvantage of the prior art is that the inefficient communication of work-order modification information to and process correction information from the manufacturing floor severely adversely affects any effort to correctly predict the time of delivery of a work-order. This problem results in unexpected delivery delays and over-stocking and thus causes loss of revenues and credibility.

There is thus a widely recognized need for, and it would be highly advantageous to have, a method and system for communicating updated work-order information in close proximity to the physical entity for which the work-order applies, and devoid of the above limitations.

### SUMMARY OF THE INVENTION

According to one aspect of the present invention there is provided a work-order management system for managing a plurality of work-orders over a factory floor, the system containing: a central controller, and a plurality of communication units, each of the communication units containing a user interface operative to provide at least one of an output to a user and an input from a user, the output and input containing current parameters of a work-order, and wherein each of the communication units is associated with a specific work-order.

According to another aspect of the present invention there is provided a work-order management system wherein a plurality of the communication units is associated with a respective plurality of components of a work-order, wherein each of the components is associated with a sub-process of the work-order, the sub-processes being performed substantially in parallel.

According to yet another aspect of the present invention there is provided a work-order management system wherein the plurality of communication units is distributed over a manufacturing floor and operative to display work-order parameters within the manufacturing floor substantially simultaneously.

According to still another aspect of the present invention there is provided a work-order management system wherein the communication unit is operative to follow a manufactured entity along a manufacturing process, the manufactured entity being associated with the work-order.

According to further another aspect of the present invention there is provided a work-order management system wherein the manufactured entity is at least one of a product being manufactured and a manufacturing batch.

Further according to another aspect of the present invention there is provided a work-order management system additionally operative to update the current parameters of the work-order in real-time.

Still further according to another aspect of the present invention there is provided a work-order management system wherein the communication unit is operative to communicate with a manufacturing management system via a communication link.

Even further according to another aspect of the present invention there is provided a work-order management system wherein the communication link is a wireless communication channel.

Additionally further according to another aspect of the present invention there is provided a work-order management system wherein the manufacturing management system is at least one of the group containing manufacturing resource planning (MRP) and enterprise resource planning (ERP).

According to another aspect of the present invention there is provided a work-order management system wherein the output comprises an indication conditioned on at least one of a value of a parameter, or a change of a value of a parameter or a combination of values of a plurality of parameters and change of values thereof.

According to yet another aspect of the present invention there is provided a work-order management system wherein the indication is at least one of visual and audible.

According to still another aspect of the present invention there is provided a work-order management system wherein the indication is a visual indication and wherein the visual indication comprises a color scheme and wherein each color of the color scheme is associated with a specific status associated with the change of a value of a parameter.

According to further another aspect of the present invention there is provided a work-order management system additionally operative to provide location information for at least one of the plurality of communication units.

Additionally according to another aspect of the present invention there is provided a work-order management system for a manufacturing environment, the environment containing a plurality of operating stations and in which work-orders take individually designated paths around the operating stations, the system containing a plurality of communication units each for association with a work-order such that the communication units are mobile with the work-order among the operating stations, and a central station for monitoring and controlling the work-orders via the communication units.

Further additionally according to yet another aspect of the present invention there is provided a work-order management system work-order management controller containing a work-order association unit; and a work-order communicating unit, wherein the work-order association unit is operative to associate each of a plurality of work-orders with one of plurality of work-order tracing units, and wherein the communication unit is operative to exchange parameters of the work-order with the work-order tracing unit.

Even further according to another aspect of the present invention there is provided a work-order management system additionally operative to configure a user interface of the work-order tracing units.

Still further according to another aspect of the present invention there is provided a work-order management system additionally operative to communicate the work-order information with a manufacturing management system.

According to another aspect of the present invention there is provided a work-order management method consisting continuously retrieving work-order information from a manufacturing management system, continuously distributing the work-order information to a plurality of work-order tracing units; and continuously communicating the information to users, wherein each of the work-order tracing units is associated with a single work-order.

According to another aspect of the present invention there is provided a work-order management method wherein the step of continuously communicating the information to users is performed via a user interface containing at least one of visually sensible and audibly sensible features

According to still another aspect of the present invention there is provided a work-order management method additionally consisting continuously moving the work-order tracing unit to follow a manufactured entity along a manufacturing process, the manufactured entity being associated with the work-order being associated with the work-order tracing unit.

According to further another aspect of the present invention there is provided a work-order management method additionally consisting collecting information related to the work-order from a user via the work-order tracing unit, and communicating the information to the manufacturing management system.

Additionally according to another aspect of the present invention there is provided a work-order management method wherein the plurality of work-order tracing units is associated with a respective plurality of components of a work-order, wherein each of the components is associated with a sub-process of the work-order, the sub-processes being performed substantially in parallel.

Further according to another aspect of the present invention there is provided a work-order management method wherein the plurality of work-order tracing units is distributed over a manufacturing floor and operative to display work-orders within the manufacturing floor substantially simultaneously.

Even further according to another aspect of the present invention there is provided a work-order management method wherein the plurality of work-order tracing units is operative to follow a manufactured entity along a manufacturing process, the manufactured entity being associated with the work-order.

Still further according to another aspect of the present invention there is provided a work-order management method wherein the steps involving continuously retrieving, continuously distributing and continuously communicating are executed in real-time.

Further according to yet another aspect of the present invention there is provided a work-order management method wherein the step of communicating information to a user comprises providing indication conditioned on at least one of a value of a parameter, or a change of a value of a parameter or a combination of values of a plurality of parameters and change of values thereof.

According to still another aspect of the present invention there is provided a work-order management method wherein the indication comprises at least one of visual and audible features.

Additionally according to another aspect of the present invention there is provided a work-order management method wherein the indication is a visual indication and wherein the visual indication comprises a color scheme and wherein each color of the color scheme is associated with a specific status associated with the change of a value of a parameter.

Further according to another aspect of the present invention there is provided a work-order management method additionally providing location information for at least one of the plurality of mobile terminal units.

Still further according to another aspect of the present invention there is provided a work-order management method for a manufacturing environment, the environment containing work-orders that take individually designated paths around a plurality of operating stations, the method containing associating each the work-order with a different mobile unit, moving the mobile unit with the associated work-order among the operating stations, and monitoring and controlling the work-orders via the mobile units.

Unless otherwise defined, all technical and scientific terms used herein have the same meaning as commonly understood by one of ordinary skill in the art to which this invention belongs. The materials, methods, and examples provided herein are illustrative only and not intended to be limiting.

Implementation of the method and system of the present invention involves performing or completing certain selected tasks or steps manually, automatically, or a combination thereof. Moreover, according to actual instrumentation and equipment of preferred embodiments of the method and system of the present invention, several selected steps could be implemented by hardware or by software on any operating system of any firmware or a combination thereof. For example, as hardware, selected steps of the invention could be implemented as a chip or a circuit. As software, selected steps of the invention could be implemented as a plurality of software instructions being executed by a computer using any suitable operating system. In any case, selected steps of the method and system of the invention could be described as being performed by a data processor, such as a computing platform for executing a plurality of instructions.

### BRIEF DESCRIPTION OF THE DRAWINGS

The invention is herein described, by way of example only, with reference to the accompanying drawings. With specific reference now to the drawings in detail, it is stressed that the particulars shown are by way of example and for purposes of illustrative discussion of the preferred embodiments of the present invention only, and are presented in order to provide what is believed to be the most useful and readily understood description of the principles and conceptual aspects of the invention. In this regard, no attempt is made to show structural details of the invention in more detail than is necessary for a fundamental understanding of the invention, the description taken with the drawings making apparent to those skilled in the art how the several forms of the invention may be embodied in practice.

In the drawings:

FIG. 1 is a simplified illustration of a manufacturing floor equipped with a work-order management system according to a preferred embodiment of the present invention;

FIG. 2 is a simplified illustration of a communication unit according to a preferred embodiment of the present invention;

FIG. 3 is a simplified block diagram of the communication unit of FIG. 2.

FIG. 4 is a simplified illustration of a work-order management system according to a preferred embodiment of the present invention;

FIG. 5 is a simplified illustration of a work-order management system according to another preferred embodiment of the present invention;

FIG. 6 is a simplified illustration of a work-order management system connected with a manufacturing management system according to still another preferred embodiment of the present invention;

FIG. 7 is a simplified block diagram of a work-order management system with a simplified detailed block diagram of the work-order controller according to a preferred embodiment of the present invention;

FIG. 8 is a simplified flow chart of a software program executed by the work-order controller according to a preferred embodiment of the present invention;

FIG. 9 is a simplified block diagram of a software package executed by the communication unit according to a preferred embodiment of the present invention;

FIG. 10 is a simplified flow chart of a software program executed by the communication unit 16, according to a preferred embodiment of the present invention; and

FIG. 11 is a simplified block diagram of three preferred wireless network topologies according to a preferred embodiment of the present invention.

### DESCRIPTION OF THE PREFERRED EMBODIMENTS

The preferred embodiment of the present invention provides a control or management system for a factory floor. More particularly it provides a plurality of work-order terminal units that are distributed over the manufacturing floor. Each of the terminals is associated with a different work-order, receiving information updates for the work-order in real-time. Thus, workers and managers on the manufacturing floor are able to view the updated status of each work-order at all times and receive alerts in real-time.

The principles and operation of a work-order information management system according to the present invention may be better understood with reference to the drawings and accompanying description.

Before explaining at least one embodiment of the invention in detail, it is to be understood that the invention is not limited in its application to the details of construction and the arrangement of the components set forth in the following description or illustrated in the drawings. The invention is capable of other embodiments or of being practiced or carried out in various ways. Also, it is to be understood that the phraseology and terminology employed herein is for the purpose of description and should not be regarded as limiting.

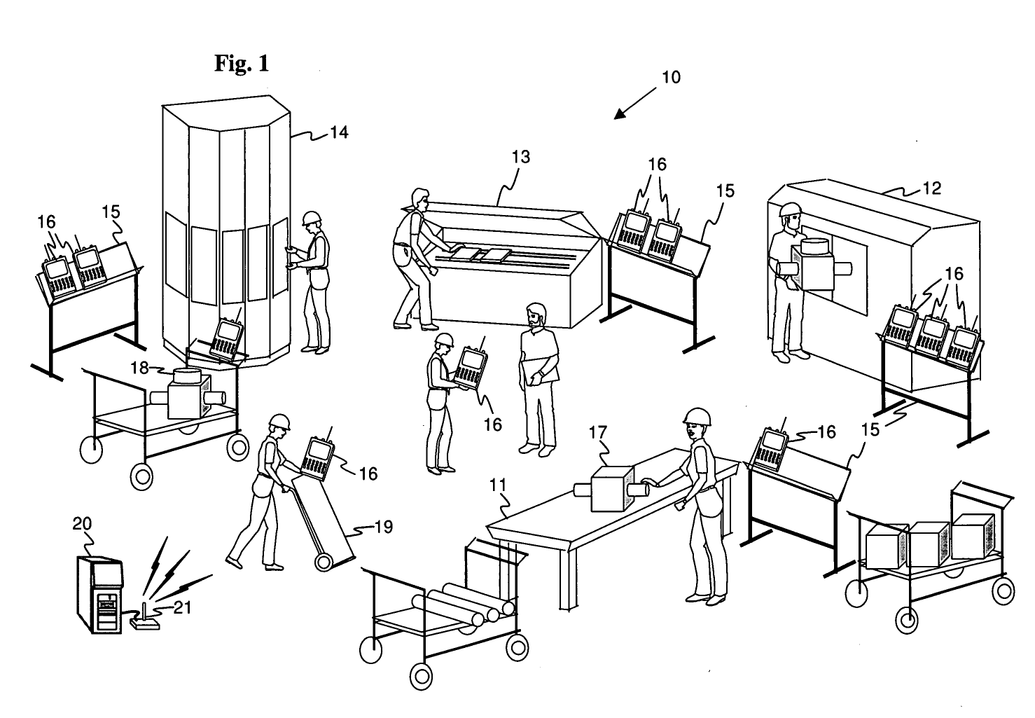

Reference is no made to FIG. 1, which is a simplified illustration of a manufacturing floor equipped with a work-order management system 10 according to a preferred embodiment of the present invention.

It is appreciated that the elements shown in FIG. 1 are not necessarily to the same scale.

FIG. 1 shows a manufacturing floor preferably equipped with four manufacturing-stations identified by numerals 11, 12, 13 and 14. A communication-unit presentation-stand 15 is preferably positioned near each of the manufacturing-stations and communication-units 16 are preferably placed on the presentation-stands 15.

Manufactured entities, such as entity 17, are in the process of being manufactured within each of the manufacturing stations. Other manufactured entities such as manufactured entity 18, are waiting for their turn in a manufacturing station, or are being transferred between stations, such as manufactured entity 19. Each of the communication units 16 is placed in close proximity to a manufactured entity. Each of the communication units 16 communicates work-order information to the users on the manufacturing floor. The work-order information is provided to the communication units 16 by a work-order controller 20 that is also responsible to collect user inputs from the communication units 16. The work-order controller 20 preferably communicates the information to the communication units 16 via a wireless network interface 21, such as IEEE 802.15.4 (Zigbee) or IEEE 802.11 (Wi-Fi). It is appreciated that any type of wireless network can be used to communicate information between the work-order controller 20 and the communication units 16, including optical communication such as IrDA, short range wireless networking via Bluetooth and wide area networking such as cellular communications.

It is appreciated that the manufactured entities as well as their work-orders take individually designated paths around the manufacturing stations and that the communication units 16 are mobile and can follow their associated manufactured entities and work-orders among the operating stations. Thus, communication units 16 function as work-order tracing units.

It is appreciated that the work-order described herein is typically and preferably associated with a manufactured entity, which may be a finished product, a part of a product, a batch of manufactured items, etc, whether within the scope of discrete manufacturing, process manufacturing, etc. It is also appreciated that the method and the system described herein also apply to the management of work-order information for maintenance jobs and applications involving a predetermined sequence of operations performed on mobile entities or over a large facility.

Reference is now made to FIG. 2, which is a simplified illustration of the communication unit 16 according to a preferred embodiment of the present invention.

As shown in FIG. 2 the communication unit 16 preferably comprises a variety of output devices such as display 22, lighting fixtures 23 and speaker 24; a variety of input devices such as keyboard 25, pointing and selection arrangement 26, soft function keys 27, special function push-buttons 28 and microphone 29. An antenna 30 or a similar wireless device is provided to maintain wireless communication.

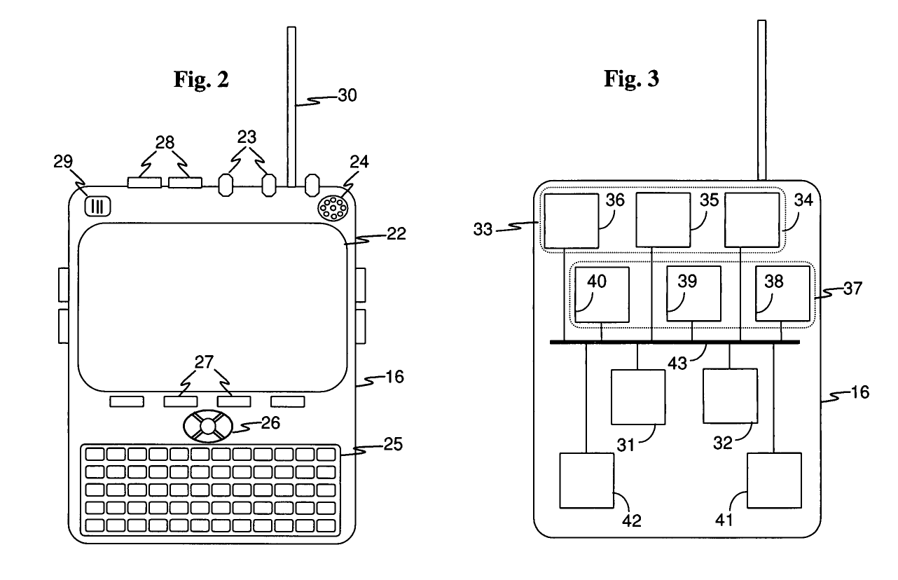

Reference is now made to FIG. 3, which is a simplified block diagram of the communication unit 16 according to a preferred embodiment of the present invention.

As shown in FIG. 3 the communication unit 16 preferably comprises a micro-controller (or a micro-processor) 31, a memory module 32, a variety of output devices drivers 33 such as display driver 34, lighting fixtures driver 35 and audio output circuitry 36; a variety of input device drivers 37 such as keyboard driver 38, pointing device driver and push-buttons driver 39 and audio input circuitry 40; a battery 41 and a wireless communication circuitry 42. Preferably all these modules are connected via a bus 43.

Referring to FIGS. 2 and 3, the display 22 is used to provide the users with the details of the work-order, for example, the identification number of the work-order, etc. The lighting fixtures 23 are used to provide the users with special statuses and alarms associated with specific aspects of the work-order. For example a red light may indicate an instruction to stop the manufacturing of the work-order, a yellow light may indicate an engineering problem, etc. The speaker 24 is used to provide the user with audible alarms and to assist, together with the microphone 29 in verbal communication with supervisors. The keyboard 25, with the aid of the pointing and selection arrangement 26 enables the user to enter detailed information about the work order and its progress, while the soft function keys 27 and special function push-buttons 28 enable the user to enter data using a single keystroke. The user is thus able to indicate that the work order is proceeding as expected, or that the work order is being held up for whatever reason or any other information that needs to be communicated. Similarly, equivalent information can be provided to the user. Simple commands such as go and stop can be provided as colored lights or as written commands appearing on the screen or as audible notifications.

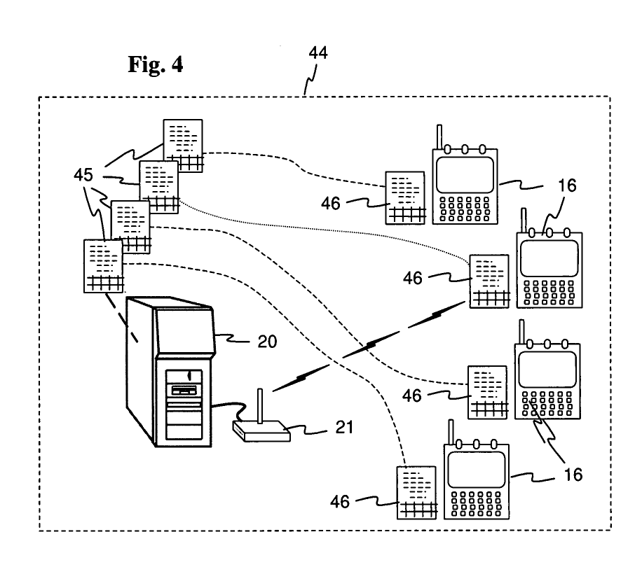

Reference is now made to FIG. 4, which is a simplified illustration of a work-order management system 44 according to a preferred embodiment of the present invention. As shown in FIG. 4, the work-order management system 44 consists of the work-order controller 20 and a plurality of the communication units 16, which are distributed over a manufacturing floor. The work-order controller 20 manages a plurality of work-orders 45 and associates each of these work-orders with one of the plurality of communications units 16. The work-order controller 20 communicates work-order updates 46 to the communications units 16 to be provided to users, visually or audibly, and receives subsequent user inputs from the communications units 16. The work-order controller 20 communicates with the communications units 16 preferably via a wireless network, typically via the wireless network interface 21.

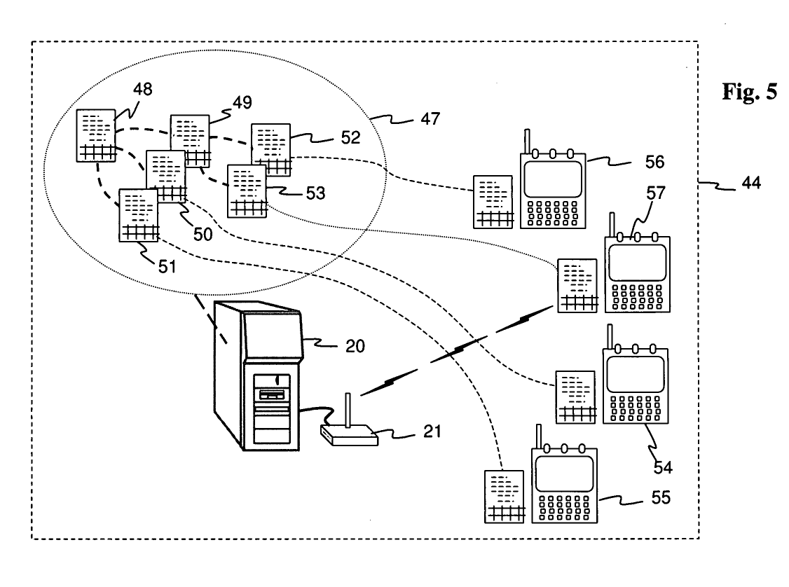

Reference is now made to FIG. 5, which is a simplified illustration of the work-order management system 44 according to another preferred embodiment of the present invention. As shown in FIG. 5, the work-order controller 20 manages a hierarchical work-order structure 47. In the example provided by FIG. 5, the root of the hierarchical work-order structure 47 is a work-order 48, which consists of three sub-processes, which are represented by work-orders 49, 50 and 51. Work-order 49 further consists of two sub-processes, which are represented by work-order 52 and 53. At the point of time presented in FIG. 5 the work orders 50, 51, 52 and 53 are associated with communication units 54, 55, 56 and 57 respectively. Typically the sub-processes are executed in parallel.

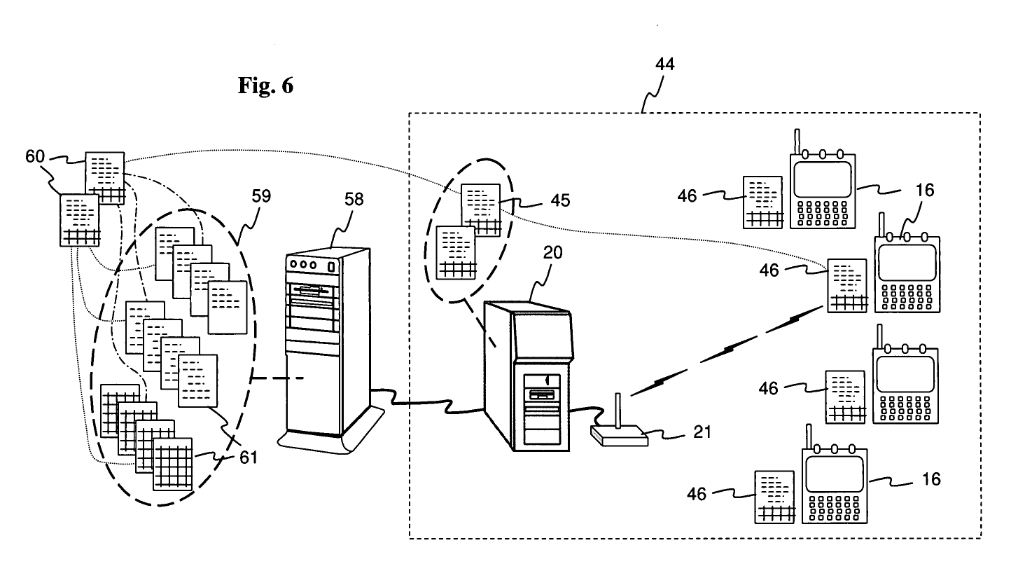

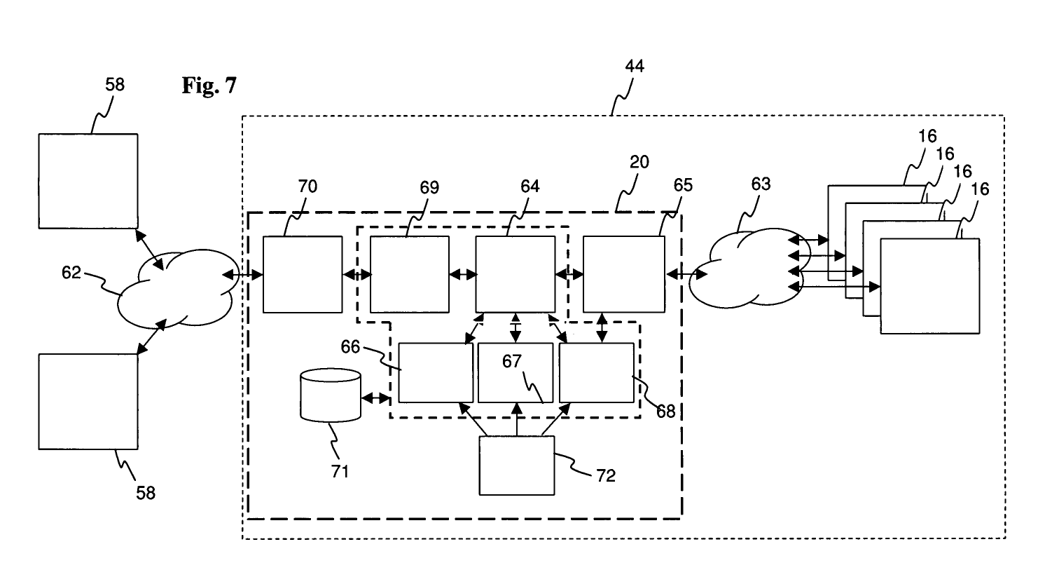

Reference is now made to FIG. 6, which is a simplified illustration of the work-order management system 44 connected with a manufacturing management system 58 according to still another preferred embodiment of the present invention.

As shown in FIG. 6, the work-order management system 44 consists of the work-order controller 20 and a plurality of the communication units 16, which are distributed over a manufacturing floor. The communication units 16 communicate with the work-order controller 20 preferably via a wireless network, preferably via a wireless network interface (base station) 21. The work-order controller 20 communicates with the manufacturing management system 58 preferably via a local area network such as the Ethernet. The manufacturing management system 58 typically hosts a database 59 comprising a plurality of work-orders 60. Typically each work-order information is distributed over several records 61, typically comprising a part of each record. The work-order controller 20 continuously interrogates the manufacturing management system 58 and retrieves the work-orders 60. The work-order controller 20 stores the retrieved work-orders (identified by numeral 45) in its database and associates each work-order 45 with a specific communication unit 16, and when the work-order controller 20 identifies that there is a change in the data of a specific work-order 60 the work-order controller 20 communicates the work-order update 46 to the associated communication units 16.

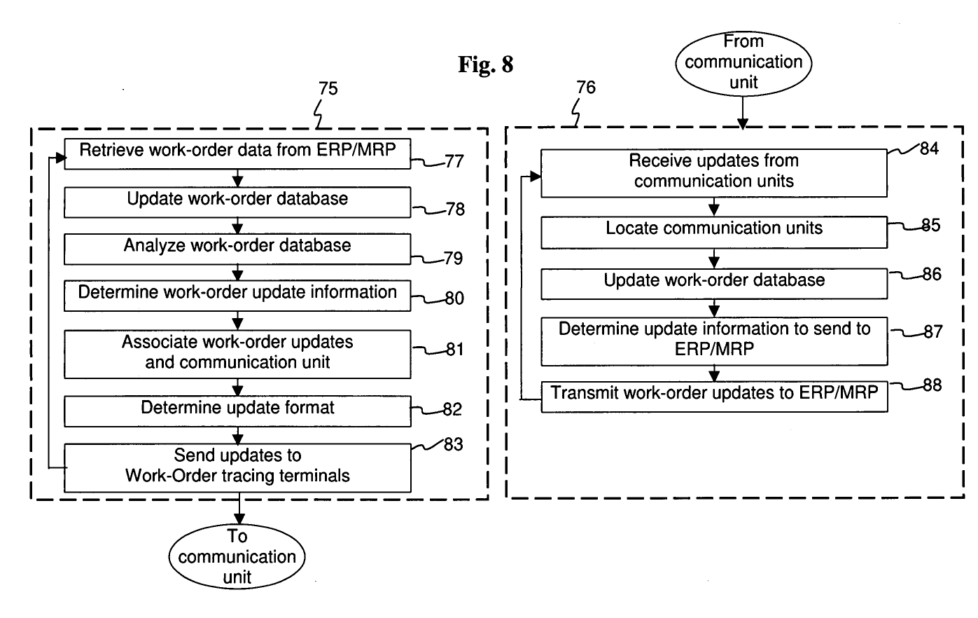

Reference is now made to FIG. 7, which is a simplified block diagram of the work-order management system 44 and particularly a simplified block diagram of the work-order controller 20, according to a preferred embodiment of the present invention. The work-order controller 20 is preferably a software package that runs on a general-purpose computer such as a desktop personal computer (PC).

As shown in FIG. 7, the work-order controller 20 is preferably connected on one hand, via a network 62, to one or more manufacturing management systems 58, and on the other hand, via a network 63, to a plurality of communication units 16. The network 62 is preferably a local area network (LAN), preferably an Ethernet LAN. The network 63 is preferably a wireless network such as IEEE 802.15.4 (Zigbee) or IEEE 802.11, 802.11a, 802.11b, 802.11g, 802.11n (Wi-Fi) or an optical network such as IrDA and wide area networking such as cellular communications.

The work-order controller 20 preferably consists of the following main modules:

a work-order distribution module 64 that connects to:
a wireless communication module 65 that connects to the wireless network 63;
a work-order association unit 66 that keeps track of the linkage between each work-order and each communication unit 16;
a user interface configuration module 67 that keeps track of the configuration of the user interface of each communication units;
a communication unit location module 68 that keeps track of the location of each of the communication units; and
a work-order analysis module 69 that connected to an ERP/MRP communication module 70 that connects to the network 62;

a storage and database module 71 that serves the work-order analysis module 69, the a work-order distribution module 64, the work-order association module 66, the user interface configuration module 67 and the communication unit location module 68; and

a user interface 72 for administrating the database, including the identification and configuration of the communication units and the manufacturing floor location map.

The work-order controller 20 connects to the manufacturing management systems 58 via the ERP/MRP communication module 70 that is customized to the export/import facility of each manufacturing management system 58 and to its database structure. Thus, the communication module 70 is able to retrieve the work-order information from the manufacturing management system 58 and to update it when necessary. The ERP/MRP communication module 70 transfers the work-order information to the work-order analysis module 69.

The work-order analysis module 69 is responsible for analyzing the work-orders' information according to predefined rules and to determine whether one or more of the communication units 16 have to be updated and how. The work-order analysis module 69 then sends an information update request to the work-order distribution module 64.

The work-order distribution module 64 is responsible to associate the information update request with the correct communication unit 16, to send the information update to the communication unit 16, to retrieve user responses from the communication units 16 and to send these responses to the work-order analysis module 69. The a work-order distribution module 64 uses information from the work-order association module 66, the user interface configuration module 67 and the communication unit location module 68 to assemble the appropriate information update message and to send it to the wireless communication module 65.

The wireless communication module 65 then sends the information update to the appropriate communication unit 16 using the appropriate protocol and using the appropriate wireless facility. The communication module 65 then retrieves user responses from the communication unit 16 and collects from the wireless facility location information for that communication unit 16. The communication module 65 then sends the collected information to the work-order distribution module 64 and to the communication unit location module 68.

The communication unit location module 68 then analyses the collected location information and determines the location of the communication unit 16 on the manufacturing floor. The location information is stored in the storage and database module 73 and is made available to the work-order distribution module 64.

The work-order distribution module 64 sends a communication unit response update to the work-order analysis module 69. The work-order analysis module 69 analyses the information received from the communication unit 16 and its movements over the manufacturing floor, and, using the ERP/MRP communication module 70, updates the appropriate manufacturing management system 58.

The user interface 72 enables an administrator of the work-order controller 20 to:

Customize the ERP/MRP communication module 70 to the export/import facility and the work-order data structure of the manufacturing management systems 58;

Configure the user interface of the communication units 16;

Associate work-order with communication units 16;

Construct a work-order division into several sub-work-orders and link these sub-work-orders into the parent work-order, associate a communication unit 16 with each sub-work-order and control these communication units within the framework of the parent work-order;

Define the manufacturing floor map and calibrate the communication units 16 location detection facility;

Define work-order analysis rules by which to update the user interface of the communication units 16 and the database of the manufacturing management systems 58;

Define the rate of scanning and update of work-orders and communication units to provide real-time and simultaneous control of both;

Manage the database within the storage and database module 74; and

Enable a user to enter additional work-order information, such as information that is not provided by the manufacturing management system 58.

It is appreciated that the user interface 72 enables the operation of the work-order controller 20 and the communication units 16 without the manufacturing management system 58, by manually entering the required work-order information to the work-order controller 20 database.

Reference is now made to FIG. 8, which is a simplified flow chart of a software program executed by the work-order controller 20, according to a preferred embodiment of the present invention.

As shown in FIG. 8, the work-order controller 20 executes two flows concurrently. One flow, referenced by numeral 75, processes work-order information flowing from the manufacturing management system 58 to the communication unit 16. The other flow, referenced by numeral 76, processes work-order information flowing from the communication unit 16 to the manufacturing management system 58.

The flow referenced by numeral 75 starts with step 77 by retrieving work-order data from the manufacturing management system 58. This step is preferably performed by the wireless communication module 70.

The work-order controller 20 then updates the work-order database (step 78), analyzes the updated work-order database (step 79), and determines the information updates to be sent to the users (step 80). The update information to be sent to the communication units 16 preferably contains data and indications that data has changed. The indications are preferably conditioned on a specific value or a specific change of a value of the data, or a combination of such values and change of values. These steps are preferably executed by the work-order analysis module 69.

The work-order controller 20 then associates the work-order updates and their respective communication units 16 (step 81. This updating is preferably executed by the distribution module 64 with the help of the association module 66. Then the work-order controller 20 adapts the update information to the user interface of each communication unit 16 (step 82). This updating is preferably executed by the distribution module 64 with the help of the user interface configuration module 67. Then the work-order controller 20 sends the update to each communication unit 16 (step 83). This updating is preferably executed by the distribution module 64 with the help of the wireless communication module 65.

The adaptation of the update information to the communication unit 16 depends on the output devices that are available on the specific communication unit 16 and the assignment of indications to each such output device. Thus, a certain lighting fixture may have a special meaning, such as a special alarm, a request for immediate human attention to an unspecified situation. Different colors may have predefined meanings. The speaker of the communication unit 16 may provide various sounds including pre-recorded phrases. While steps 79 and 80 determine the content of the update information to be sent to the communication unit 16, steps 81 and 82 determine the audible and visual format of each part of the content of the update information to be sent to the communication unit 16. The audible and visual formats depend on the type of the data and indication and the type of the communication unit 16 and its output devices.

Further examples of preferred indications provided by the output devices of the communication unit 16 are:

Manufacturing planned time is over. A yellow light starts to blink Typically the user responds by pressing an acknowledgement key, the acknowledgement information is then sent to the work-order controller 20, which preferably sends the information to the manufacturing management system 58, and the blinking stops.

Engineering change order (ECO) has been received. A user, preferably a planner, enters new information to the manufacturing management system 58. The work-order controller 20 picks up the ECO and sends the relevant information update to the appropriate communication unit 16. Consequently, a red light is turned on at the communication unit 16 to indicate that the manufacturing of the associated work-order should be stopped. The planner goes to the shop floor to fix the problem using location information received from the communication unit 16 and the work-order controller 20.

When a part of the manufactured entity is manufactured by a contractor remotely from the main manufacturing facility, a communication unit 16 is placed within sight of the manufacturing supervisor's station to provide information about the outsourced work-order.

Preferably, when a work-order is finished, the communication unit is reset and returned to the designer station to be configured for another work-order.

The work-order information management system preferably enables the manufacturer to optimize his delivery time, typically as follows:

Providing order priority changes to shop floor workers in real time;

Automatic and real-time bi-directional information transfer between the shop floor and the manufacturing management system 58; and

Performing complicated manufacturing management methods using the work-order controller 20 as an interface to reconfigure the communication units 16.

It is appreciated that there may be several different models of communication units in use, and even for the same communication unit there may be different uses for the same Input/Output devices. The user interface may change from one manufacturing entity to the other and it can also change in accordance with the stage of the manufacturing process (e.g. according to the current manufacturing station). For example, an alarm can be implemented as an audible sound, or by turning on a lighting fixture, or by displaying an icon on the display, or by highlighting a text. The choice of the type of alarm may depend on the type of the information and on the ambient situation as is now common with cellular telephones. Hence, depending on the noise level it is possible to use audible alarms of different types or to disable audible alarms if so required. It is also possible to use lighting effects to draw attention or to use vibration.

The flow referenced by numeral 76 starts with step 84 to receive user inputs from the communication units 16, which is preferably executed by the distribution module 64 with the help of the wireless communication module 65.

The work-order controller 20 then determines the location of each communication unit 16 on the manufacturing floor (step 85), which is preferably executed by the location module 68 with the help of the wireless communication module 65.

Based on the information received from the communication unit 16 and their location, the work-order controller 20 executes step 86 to updates its database.

The work-order controller 20 then proceeds to step 87 to determine the information and format to update the manufacturing management system 58. This updating is preferably executed by the work-order analysis module 69.

Then the work-order controller 20 sends the updates to the manufacturing management system 58 (step 88), preferably executed by ERP/MRP communication module 70.

It is appreciated that both flows 75 and 76, namely the steps of 77 to 83 and 84 to 88, are executed continuously in a loop, and concurrently, scanning all work-orders and all communication units 16.

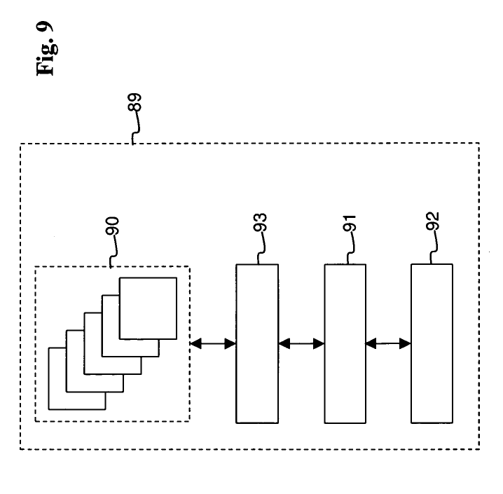

Reference is now made to FIG. 9, which is a simplified block diagram of a software package 89 executed by the communication unit 16 according to a preferred embodiment of the present invention. The software package preferably consists of a library 90 of drivers of the input and output devices of the specific communication device, a protocol manager 91, a wireless communication manager and device driver 92 depending on the type of wireless technology and device used, and a data management module 93, which manages the operation of the communication unit. The data management module 93 is preferably responsible for the following functions:

The configuration of the communication unit according to configuration information received from the work-order controller. It is noted that, during the configuration process the communication unit communicates with the work-order controller station either by the wireless communication backbone or by wire cable. The configuration preferably includes:

a communication unit ID number;

the work-order number that associates the communication unit with the work-order. Each communication unit can be configured with ID number multiple times;

system parameters such as: initial logical conditions, frequencies of the wireless devices, hardware initial parameters such as display intensity and contrast, etc;

communication unit Operation Mode selector that preferably enables the communication unit to be operated in one of two operation modes:

Normal mode, in which the communication unit preferably operates at full functionality until it is receives an instruction to go to sleep mode; and

Sleep Mode, in which the communication unit has limited functionality, such as waiting for an internal interrupt, for example a timer at which the communication unit wakes-up for a fixed time interval and operates in full functionality before it returns to sleep. Sleep mode is typically useful to preserve battery life;

Data processing, which enables the communication unit to make logical decisions based on user inputs and information received form the work-order controller;

Data Storage that enables the communication unit to store data, typically of at least 1 Mbyte. This may be useful for example for receiving data from the keyboard; and

Maintenance service that enables testing and analysis of fault situations including storing an activity log file and transmitting (either by wireless communication or by wired cable) it to the work-order controller upon request.

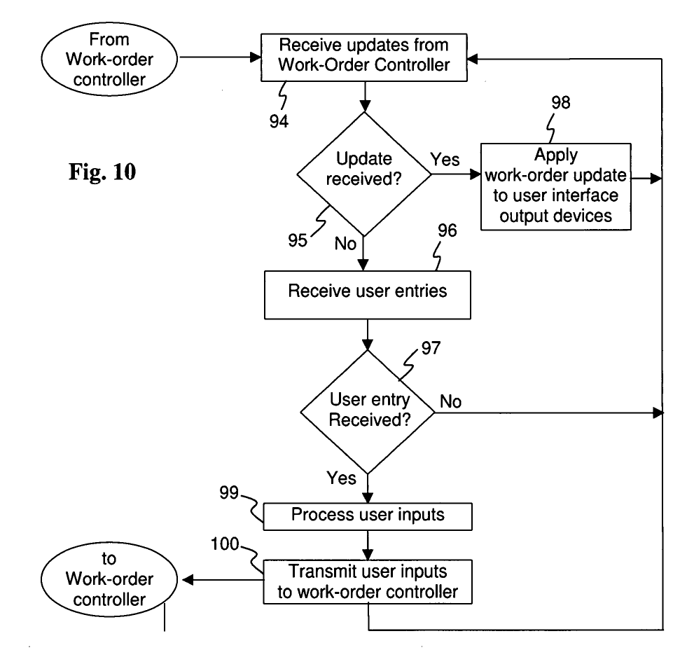

Reference is now made to FIG. 10, which is a simplified flow chart of a software program executed by the communication unit 16, according to a preferred embodiment of the present invention

As shown in FIG. 10, the communication unit 16 continuously waits for updates from the work-order controller 20 (steps 94 and 95) and for user entries (steps 96 and 97). When the communication unit 16 receives an update from the work-order controller 20 the communication unit 16 operates its output devices according to the instructions and configuration of the user interface (step 98). When a user response is received the communication unit 16 processes the response (step 99) and then sends the response to the work-order controller 20 (step 100).

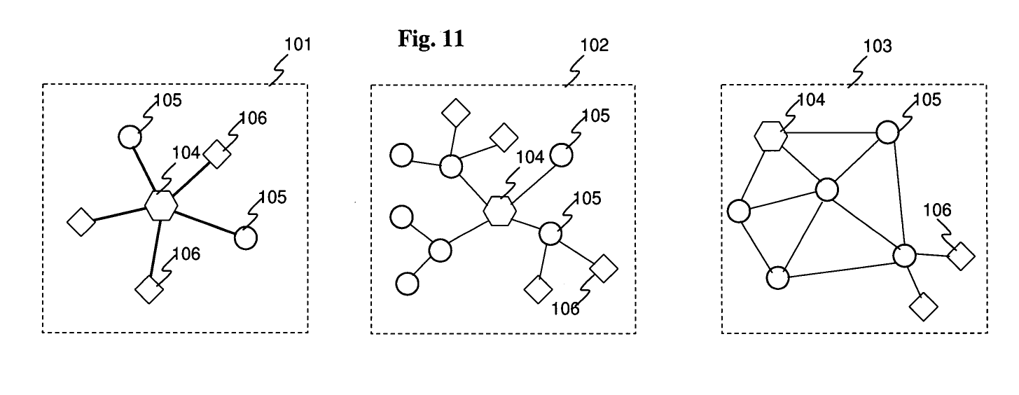

Reference is now made to FIG. 11, which is a simplified block diagram of three preferred wireless network topologies according to a preferred embodiment of the present invention. Network topology 101 is a star topology, Network topology 102 is a cluster tree topology, and Network topology 103 is a mesh topology. All three topologies and their combinations can be used to provide the wireless network between the work-order controller and the communication units. The wireless networks shown in FIG. 11 preferably consists of three types of nodes, a coordinator node 104, a routing node 105, and an end-device node 106. Preferably the nodes are the work-order controller and the communication units. Preferably the work-order controller is a coordinator node and the end-device nodes are the communication units.

It is appreciated that the work-order management system 10 is additionally capable of managing groups of work-orders, typically arranged under the entity of a project. Preferably, the work-order controller 20 enables a user, typically an administrator or a project planner, to define a project, preferably as a group of work-orders, and then to configure a group of communication units 16 and associate each of them with the project and with each of the work-orders consisting the project. The information regarding the project, as well as the information of the respective work-order, are then transmitted to the communication units 16. Preferably, such information may consist:

The communication units 16 ID number.

The work-order ID number.

The communication unit 16 initial mode of operation (normal, sleep, etc.).

The communication unit 16 initial output status (lights, display, etc.).

The communication unit 16 initial operational rules and logic (e.g. how to respond to user inputs).

Customization and operational rules and logic regarding the interaction with the manufacturing management system 58.

Structure and definition of project parameters that are not part of the manufacturing management system 58.

Customization of messages to users by e-mail, SMS, etc.

Online updating of the above.

Online upgrading of the software of the communication unit 16.

It is expected that during the life of this patent many relevant input devices, output devices, communication devices and systems will be developed and the scope of the terms herein is intended to include all such new technologies a priori.

It is appreciated that certain features of the invention, which are, for clarity, described in the context of separate embodiments, may also be provided in combination in a single embodiment. Conversely, various features of the invention, which are, for brevity, described in the context of a single embodiment, may also be provided separately or in any suitable sub-combination.

Although the invention has been described in conjunction with specific embodiments thereof, it is evident that many alternatives, modifications and variations will be apparent to those skilled in the art. Accordingly, it is intended to embrace all such alternatives, modifications and variations that fall within the spirit and broad scope of the appended claims. All publications, patents and patent applications mentioned in this specification are herein incorporated in their entirety by reference into the specification, to the same extent as if each individual publication, patent or patent application was specifically and individually indicated to be incorporated herein by reference. In addition, citation or identification of any reference in this application shall not be construed as an admission that such reference is available as prior art to the present invention.

What is claimed is:

1. A work-order management system for managing a plurality of work-orders over a factory floor, the system comprising:
a central controller, and
a plurality of communication units, each of said communication units comprising a user interface operative to provide at least one of an output to a user and an input from a user, said output and input comprising current parameters of a work-order, and wherein each of said communication units is associated with a specific work-order.

2. A work-order management system according to claim 1 wherein a plurality of said communication units is associated with a respective plurality of components of a work-order, wherein each of said components is associated with a sub-process of said work-order, said sub-processes being performed substantially in parallel.

3. A work-order management system according to claim 1 wherein said plurality of communication units is distributed over a manufacturing floor and operative to display work-order parameters within said manufacturing floor substantially simultaneously.

4. A work-order management system according to claim 1 wherein said communication unit is operative to follow a manufactured entity along a manufacturing process, said manufactured entity being associated with said work-order.

5. A work-order management system according to claim 4 wherein said manufactured entity is at least one of a product being manufactured and a manufacturing batch.

6. A work-order management system according to claim 1 and operative to update said current parameters of said work-order in real-time.

7. A work-order management system according to claim 1 wherein said communication unit is operative to communicate with a manufacturing management system via a communication link.

8. A work-order management system according to claim 7 wherein said communication link is a wireless communication channel.

9. A work-order management system according to claim 7 wherein said manufacturing management system is at least one of the group comprising manufacturing resource planning (MRP) and enterprise resource planning (ERP).

10. A work-order management system according to claim 1 wherein said output comprises an indication conditioned on at least one of a value of a parameter, or a change of a value of a parameter or a combination of values of a plurality of parameters and change of values thereof.

11. A work-order management system according to claim 10 wherein said indication is at least one of visual and audible.

12. A work-order management system according to claim 11 wherein said indication is a visual indication and wherein said visual indication comprises a color scheme and wherein each color of said color scheme is associated with a specific status associated with said change of a value of a parameter.

13. A work-order management system according to claim 1 additionally operative to provide location information for at least one of said plurality of communication units.

14. A work-order management system for a manufacturing environment, said environment comprising a plurality of operating stations and in which work-orders take individually designated paths around said operating stations, said system comprising:
a plurality of communication units each for association with a work-order such that said communication units are mobile with said work-order among said operating stations, and
a central station for monitoring and controlling said work-orders via said communication units.

15. A work-order management controller comprising
a work-order association unit; and
a work-order communicating unit,
wherein said work-order association unit is operative to associate each of a plurality of work-orders with one of plurality of work-order tracing units, and wherein said communication unit is operative to exchange parameters of said work-order with said work-order tracing unit.

16. A work-order management controller according to claim 15 additionally operative to configure a user interface of said work-order tracing units.

17. A work-order management controller according to claim 15 and additionally operative to communicate said work-order information with a manufacturing management system.

18. A work-order management method comprising:
continuously retrieving work-order information from a manufacturing management system;
continuously distributing said work-order information to a plurality of work-order tracing units; and
continuously communicating said information to users,
wherein each of said work-order tracing units is associated with a single work-order.

19. A work-order management method according to claim 18 wherein said step of continuously communicating said information to users is performed via a user interface comprising at least one of visually sensible and audibly sensible features

20. A work-order management method according to claim 18 and additionally comprising continuously moving said work-order tracing unit to follow a manufactured entity along a manufacturing process, said manufactured entity being associated with said work-order being associated with said work-order tracing unit.

21. A work-order management method according to claim 18 and additionally comprising:
collecting information related to said work-order from a user via said work-order tracing unit; and
communicating said information to said manufacturing management system.

22. A work-order management method according to claim 18 wherein said plurality of work-order tracing units is associated with a respective plurality of components of a work-order, wherein each of said components is associated with a sub-process of said work-order, said sub-processes being performed substantially in parallel.

23. A work-order management method according to claim 18 wherein said plurality of work-order tracing units is distributed over a manufacturing floor and operative to display work-orders within said manufacturing floor substantially simultaneously.

24. A work-order management method according to claim 18 wherein said plurality of work-order tracing units is operative to follow a manufactured entity along a manufacturing process, said manufactured entity being associated with said work-order.

25. A work-order management method according to claim 18 wherein said steps involving continuously retrieving, continuously distributing and continuously communicating are executed in real-time.

26. A work-order management method according to claim 18 wherein said step of communicating information to a user comprises providing indication conditioned on at least one of a value of a parameter, or a change of a value of a parameter or a combination of values of a plurality of parameters and change of values thereof.

27. A work-order management method according to claim 26 wherein said indication comprises at least one of visual and audible features.

28. A work-order tracing method according to claim 27 wherein said indication is a visual indication and wherein said visual indication comprises a color scheme and wherein each color of said color scheme is associated with a specific status associated with said change of a value of a parameter.

29. A work-order management method according to claim 18 additionally providing location information for at least one of said plurality of mobile terminal units.

30. A work-order management method for a manufacturing environment, said environment comprising work-orders that take individually designated paths around a plurality of operating stations, said method comprising:
associating each said work-order with a different mobile unit;
moving said mobile unit with said associated work-order among said operating stations; and
monitoring and controlling said work-orders via said mobile units.
